(19) United States
(12) Patent Application Publication
(10) Pub. No.: US 2024/0310121 A1
(43) Pub. Date: Sep. 19, 2024

(54) APPARATUS FOR REMOVING MOISTURE FROM PARTICULATE MATERIAL

(71) Applicant: COOMTECH LIMITED, London (GB)

(72) Inventors: Peter ANDERSON, Norfolk (GB); Paul TAYLOR, Norfolk (GB)

(73) Assignee: COOMTECH LIMITED, London (GB)

(21) Appl. No.: 18/691,833

(22) PCT Filed: Sep. 29, 2023
(86) PCT No.: PCT/IB2023/059784

§ 371 Date: Mar. 13, 2024

(30) Foreign Application Priority Data
Aug. 4, 2022 (GB) 2211361.7

(51) Int. Cl. F26B 17/10; F26B 21/10; F26B 25/00; F26B 25/22

(52) U.S. Cl. CPC F26B 17/107; F26B 21/10; F26B 25/002; F26B 25/008; F26B 25/22; F23K 2201/20; F26B 2200/02

(57) ABSTRACT

An apparatus 100 for removing moisture from particulate material is provided. The apparatus 100 comprises a master chamber 102 having a master inlet 104 for the supply of gas to the master chamber 102. The apparatus 100 further includes a plurality of drying chambers 106 at least partially arranged within the master chamber 102. Each drying chamber 106 that is at least partially arranged within the master chamber 102 has a first end and a second end, wherein each drying chamber 106 is configured for directing a flow of gas-entrained particulate material between said first and second ends of the drying chamber 106. Each drying chamber 106 includes a plurality of dryer inlets for directing gas from the master chamber 102 into the drying chamber 106, for interacting with said flow of gas-entrained particulate material within the drying chamber 106.

### FIELD

The present disclosure relates to an apparatus for use in removing moisture from particulate material, such as coal or biomass.

### BACKGROUND

It is known to dry wet particulate material (e.g. wet coal, fly ash, etc.) using thermal drying processes to remove moisture, in particular surface moisture. However, thermal drying processes are very energy intensive, which leads to negative cost and environmental impacts. Drying processes with reduced thermal inputs are of huge value for mitigating these negative impacts, but it can be difficult to maintain a high level of drying performance and/or throughput with such processes.

The present disclosure seeks to overcome, or at least mitigate, one or more problems of the prior art.

### SUMMARY

According to a first aspect of the disclosure, there is provided an apparatus for removing moisture from particulate material,
wherein the apparatus comprises a master chamber having a master inlet for the supply of gas to the master chamber;
wherein the apparatus further includes a plurality of drying chambers at least partially arranged within the master chamber;
wherein each drying chamber that is at least partially arranged within the master chamber has a first end and a second end, and wherein each drying chamber is configured for directing a flow of gas-entrained particulate material between said first and second ends of the drying chamber;
further wherein each drying chamber includes a plurality of dryer inlets for directing gas from the master chamber into the drying chamber, for interacting with said flow of gas-entrained particulate material within the drying chamber.

It will be understood that having a plurality of drying chambers provides for a larger throughput through the apparatus, in comparison to an apparatus having a single drying chamber of similar size/construction. Moreover, having the plurality of drying chambers at least partially arranged within a master chamber provides a more compact arrangement than having a plurality of drying chambers each arranged within a separate plenary chamber.

It will be understood that as gas from the master chamber is directed into the drying chambers, the interaction of this gas with the flow of gas-entrained particulate material within the drying chambers (e.g. striking and shocking of the gas-entrained particulate material) provides the drying contribution of the apparatus. This drying contribution is non-thermal, which is in sharp contrast to conventional “heated” drying chambers.

In exemplary embodiments, gas supplied to the master chamber may be heated prior to entering the apparatus through the master inlet. However, the drying contribution in such applications is still the non-thermal process discussed above. The pre-heating of gas outside of the apparatus only provides an auxiliary contribution by increasing the capacity of the gas to hold moisture removed from the particulate material by the interaction of the gas with the flow of gas-entrained particulate material within the drying chambers.

In exemplary embodiments, in use, the master chamber is arranged in fluid communication with a source of gas under pressure, via said master inlet, whereby each drying chamber is provided with a flow of gas under pressure, via said dryer inlets.

Such a flow of gas under pressure will interact with a flow of gas-entrained particulate material within the drying chamber, which facilitates drying of said particulate matter.

In exemplary embodiments, the apparatus comprises a control system configured to:
monitor outflow from the first or second end of each drying chamber;
for each drying chamber, determine a property indicative of drying performance from the monitored outflow (e.g. moisture content, particulate material concentration, flow rate etc.); and
when it is determined that the property indicative of drying performance in one of the drying chambers is below a threshold value, implement one or more of the following steps:
reduce the inflow of gas-entrained particulate material into said drying chamber;
increase a temperature of gas supplied to the master chamber; and
block the outflow from said drying chamber.

It will be understood that such a property indicative of drying performance is also indicative of the way in which gas under pressure is entering and flowing through the respective drying chamber. By reducing the inflow of gas-entrained particulate material into said drying chamber, the drying performance may be increased. Similarly, by increasing a temperature of gas supplied to the master chamber, the drying performance may be increased. If it is not possible to achieve a suitable drying performance in a drying chamber, blocking outflow from said drying chamber allows the drying chamber to be shut down (e.g. by also blocking inflow into the drying chamber) without impacting the performance of the other drying chambers, since the pressure within the blocked drying chamber would equalise with the pressure in the master chamber.

In exemplary embodiments, the control system is further configured to vary the rate of gas supplied to the master chamber depending on the monitored outflow of the drying chambers and/or depending on the number of drying chambers which are blocked.

Since the plurality of drying chambers are supplied by a common source of gas under pressure in the master chamber, any issues with drying performance of one chamber (e.g. due to blocked dryer inlets) would have an effect on the properties of the gas in the master chamber (e.g. increased pressure). This would have a knock-on effect on the rate of flow and/or drying performance of the other drying chambers. Therefore, the control system being configured to vary the rate of gas supplied to the master chamber depending on the monitored outflow and/or the number of drying chambers which are blocked allows a gas pressure/flow appropriate for drying to be maintained.

In exemplary embodiments, the control system is configured to reduce the rate of gas supplied to the master chamber when one or more of the drying chambers are blocked.

Such a control system allows a gas pressure/flow appropriate for drying to be maintained.

In exemplary embodiments, the apparatus comprises a plurality of control valves which are each located at the first or second end of one of the drying chambers, wherein each control valve comprises a closed state for blocking the outflow from the respective drying chamber and an open state for permitting outflow from the respective drying chamber.

Such control valves provide a simple means of selectively blocking outflow from the drying chambers.

In exemplary embodiments, the control system is configured to adjust an opening position of each control valve in order to control outflow from the respective drying chamber.

In exemplary embodiments, the control system is configured to adjust the opening positions of the control valves in order to balance outflow from the plurality of drying chambers.

Such a configuration facilitates uniform drying performance in the different drying chambers.

In exemplary embodiments, each drying chamber is of elongate configuration, having a longitudinal axis extending between said first and second ends.

In exemplary embodiments, each plurality of dryer inlets comprises an array of spaced apart dryer inlets, wherein said dryer inlets are spaced apart in series along the longitudinal axis of the respective drying chamber.

Such an array of spaced apart dryer inlets has been found to facilitate effective drying performance.

In exemplary embodiments, said plurality of drying chambers are arranged parallel to one another within the master chamber.

Such an arrangement provides a compact apparatus.

In exemplary embodiments, said plurality of drying chambers are arranged spaced apart from one another within the master chamber. Accordingly, in exemplary embodiments, said plurality of drying chambers are arranged with an air gap about a periphery of each drying chamber, for flow of gas around the periphery of each drying chamber within the master chamber.

Such an arrangement ensures that gas is free to flow throughout the master chamber so that each drying chamber receives a substantially equal flow of gas through the dryer inlets.

In exemplary embodiments, the plurality of drying chambers are mounted on one or more common supports.

This provides a simple means for positioning the drying chambers within the master chamber.

In exemplary embodiments, the master chamber is of elongate configuration having a longitudinal axis extending between first and second ends of the master chamber.

Such an elongate configuration provides a compact chamber for housing a plurality of elongate drying chambers.

In exemplary embodiments, the master chamber comprises opposing end plates.

In exemplary embodiments, the plurality of drying chambers are supported by said end plates.

This provides a simple arrangement without the need for separate additional support components.

In exemplary embodiments, the end plates define apertures through which the drying chambers extend.

Such apertures provide a simple means of supporting the drying chambers.

In exemplary embodiments, the apparatus comprises a plurality of heat-resistant seals (e.g. a heat-resistant compressible seals) between the apertures of the end plates and the respective drying chambers.

Such heat-resistant seals help maintain gas inside the master chamber at high pressure.

In exemplary embodiments, each drying chamber is intended to be mounted with the longitudinal axis arranged horizontally.

It will be understood that, in such exemplary embodiments where each drying chamber is intended to be mounted with the longitudinal axis arranged horizontally, particulate material passes through the drying chambers in a horizontal direction. To achieve this horizontal flow, the particulate material is gas-entrained and propelled sideways between the first and second ends of the drying chamber. This is a sharp contrast to known drying systems in which the flow of particulate material is exclusively or predominantly vertical (e.g. gravity-fed systems in which particulate material flows vertically downwards under the force of gravity).

### BRIEF DESCRIPTION OF THE DRAWINGS

The present disclosure will now be described, by way of example only, with reference to the following figures in which:

FIG. 1 is an isometric view of an apparatus for removing moisture from particulate material according to an embodiment;

FIG. 2 is an end view of the apparatus of FIG. 1;

FIG. 3 is a side view of the apparatus of FIGS. 1 and 2 connected to a control system; and

FIG. 4 is a schematic side view of a drying chamber of the apparatus of FIGS. 1 to 3.

### DETAILED DESCRIPTION

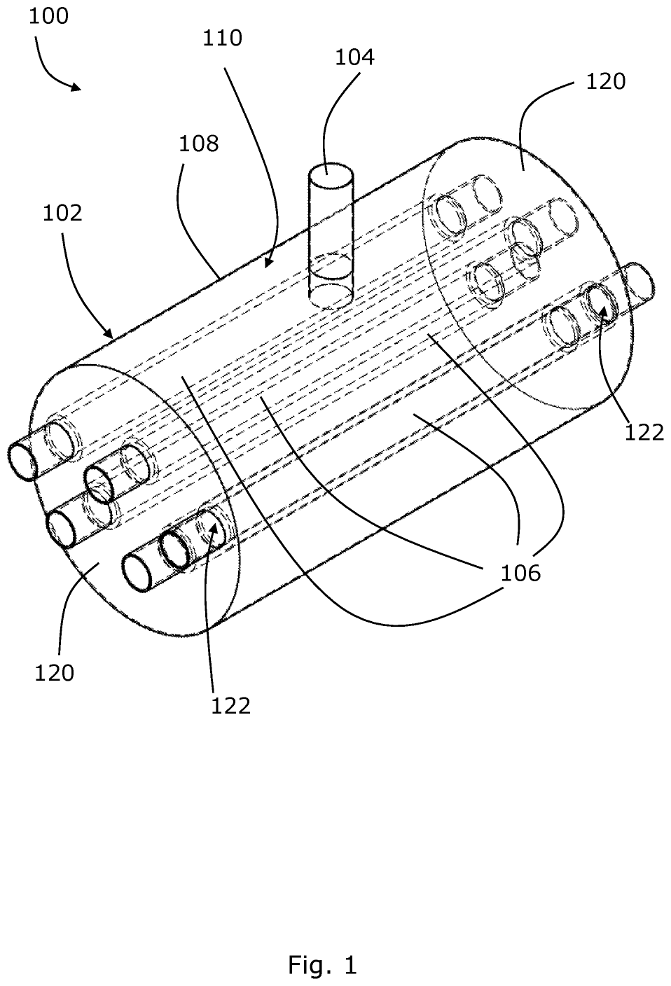

Referring firstly to FIGS. 1 to 3, there is provided an apparatus for removing moisture from particulate material 100, which has a master chamber 102 having a master inlet 104 for the supply of gas to the master chamber 102.

As can be seen, the apparatus 100 includes a plurality of drying chambers 106 at least partially arranged within the master chamber 102.

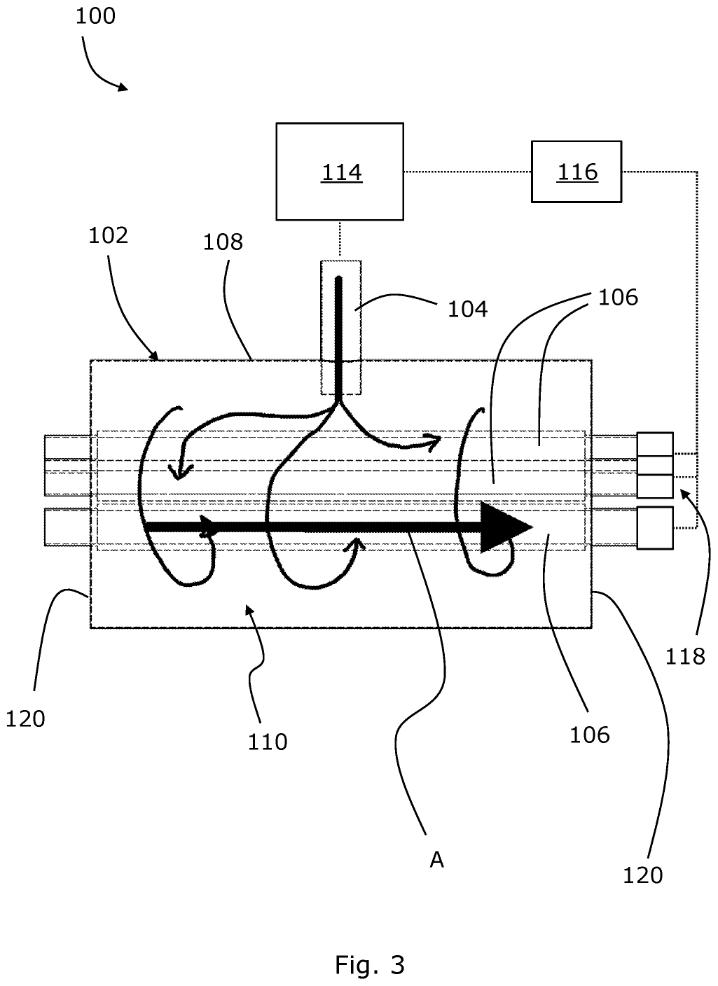

It will be understood that each drying chamber 106 has a first end and a second end, and each drying chamber 106 is configured for directing a flow of gas-entrained particulate material between said first and second ends of the drying chamber 106 (e.g. in the horizontal direction of arrow A on FIG. 3).

The master chamber 102 has a body 108 of elongate configuration having a longitudinal axis extending between first and second ends of the master chamber 102. The body 108 defines an internal plenum 110. One or both of the ends of each drying chamber 106 may be located outside of the body 108 or plenum 110 of the master chamber 102, such that any mechanism (not shown) required for introducing or collecting the flow of particulate material is located external to the master chamber 102.

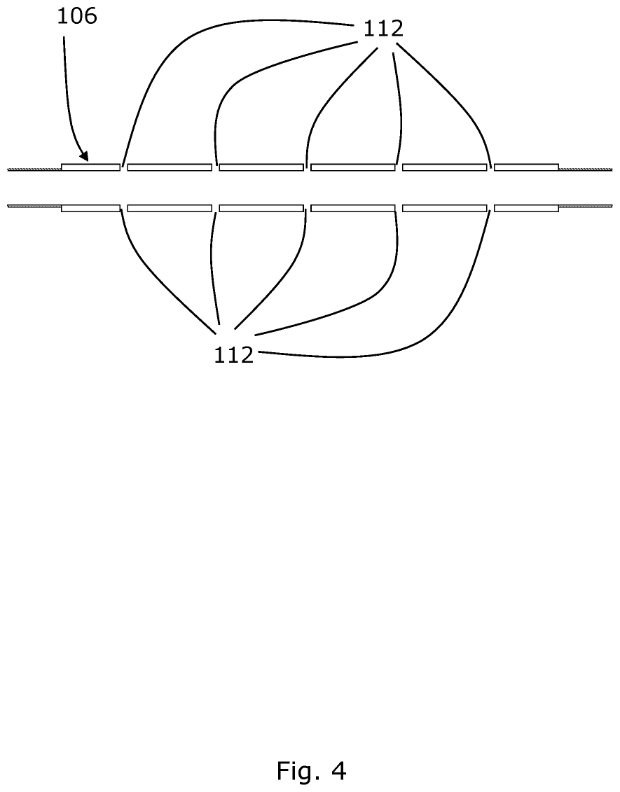

Each drying chamber 106 includes a plurality of dryer inlets 112 (as shown schematically in FIG. 4) for directing gas from the plenum 110 of the master chamber 102 into the drying chamber 106, for interacting with said flow of gas-entrained particulate material within the drying chamber 106.

In exemplary embodiments, in use, the master chamber 102 is arranged in fluid communication with a source of gas under pressure 114 (shown schematically in FIG. 3), via said master inlet 104, whereby each drying chamber 106 is supplied with a flow of gas under pressure, via said dryer inlets 112.

In the embodiment illustrated in FIG. 3, the apparatus 100 includes a control system 116 configured to monitor outflow from the first or second end of each drying chamber 106. The control system 116 is also configured, for each drying chamber, to determine a property indicative of drying performance from the monitored outflow (e.g. moisture content, particulate material concentration, flow rate etc.). When it is determined that the property indicative of drying performance in one of the drying chambers is below a threshold value, the control system 116 is configured to implement one or more of the following steps: reduce the inflow of gas-entrained particulate material into said drying chamber 106; increase a temperature of gas supplied to the master chamber 102; and block the outflow from said drying chamber 106.

In order to selectively block the outflow from the drying chambers 106, the apparatus 100 includes a plurality of control valves 118 which are each located at the end of a respective drying chamber 106 (i.e. the end through which gas-entrained particulate matter exits the drying chamber 106). Each control valve 118 has a closed state for blocking the outflow from the respective drying chamber 106 and an open state for permitting outflow from the respective drying chamber 106.

In exemplary embodiments, the control system 116 is configured to adjust an opening position of each control valve 118 in order to control outflow from the respective drying chamber 106. In some embodiments, the control system 116 is configured to adjust the opening positions of the control valves 118 in order to balance outflow from the plurality of drying chambers 106, which facilitates uniform drying performance in the different drying chambers 106.

In exemplary embodiments, the control system 116 is configured to vary the rate of gas supplied to the master chamber 102 from the source of gas under pressure 114 depending on the monitored outflow of the drying chambers 106 and/or depending on the number of drying chambers which are blocked (i.e. the number of control valves 118 which are in the closed state). For example, in exemplary embodiments the control system 116 is configured to reduce the rate of gas supplied to the master chamber 102 when one or more of the drying chambers are blocked (i.e. when one of more of the control valves 118 are closed).

In exemplary embodiments, one or more of said plurality of drying chambers 106 may be of a similar kind and configuration or purpose as dryers described and illustrated in PCT/GB2017/053312 or PCT/GB2012/000348.

As can be seen, each drying chamber 106 is of elongate configuration, having a longitudinal axis extending between said first and second ends. It will be understood that each drying chamber 106 is intended to be mounted with its longitudinal axis arranged horizontally, as shown in the figures.

Each plurality of dryer inlets 112 has an array of spaced apart dryer inlets, e.g. wherein said dryer inlets 112 are spaced apart in series along the longitudinal axis of the respective drying chamber 106 (as shown schematically in FIG. 4).

In the illustrated embodiments, said plurality of drying chambers 106 are arranged parallel to one another within the master chamber 102. That is to say, the longitudinal axes of the drying chambers are parallel to one another.

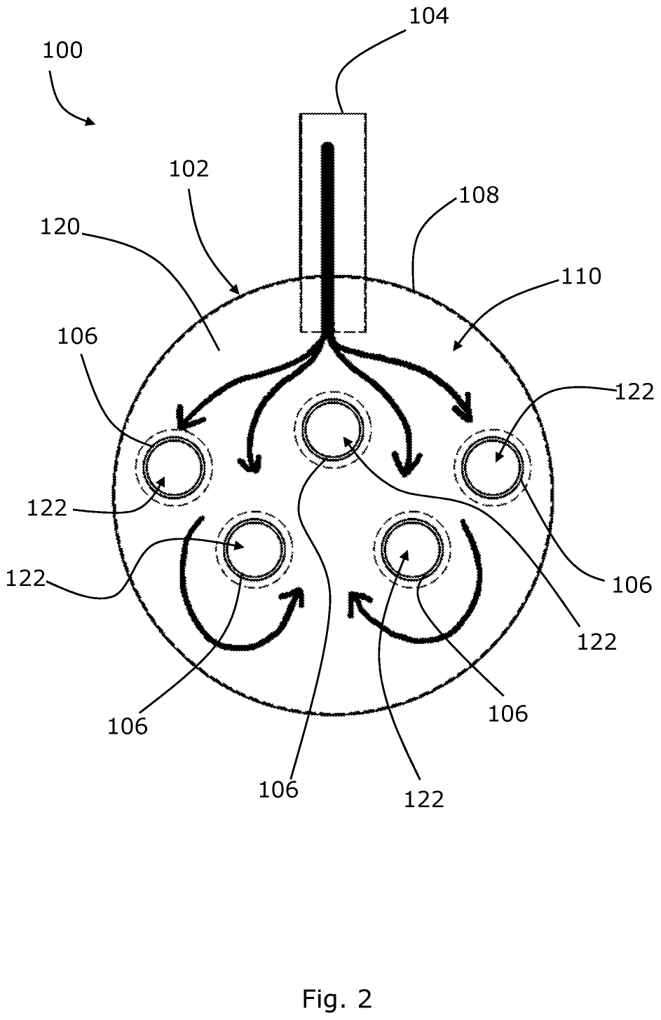

In the illustrated embodiments, the plurality of drying chambers 106 are arranged spaced apart from one another within the master chamber 102. In particular, the plurality of drying chambers 106 are arranged with an air gap about a periphery of each drying chamber (as best illustrated in FIG. 2), for flow of gas around the periphery of each drying chamber 106 within the master chamber 102.

In the illustrated embodiments, the plurality of drying chambers 106 are mounted on common supports. In particular, the master chamber 102 has opposing end plates 120 and the plurality of drying chambers 106 are supported by the end plates 106. The end plates 120 define apertures 122 through which the drying chambers 106 extend.

In exemplary embodiments, the apparatus comprises a plurality of heat-resistant seals (e.g. a heat-resistant compressible seals) between the apertures 122 of the end plates 120 and the respective drying chambers 106.

Although the disclosure has been described in relation to one or more embodiments, it will be appreciated that various changes or modifications can be made without departing from the scope of the invention as defined in the appended claims. For example, while the illustrated embodiment shows an array of five drying chambers 106 within one master chamber 102, said plurality of drying chambers 106 may number more or less drying chambers 106 (e.g. between 2 and 10 drying chambers 106). The decision on the total number of drying chambers 106 of said plurality of drying chambers 106 will be dependent on numerous factors of size and scale, e.g. to suit viable commercial activity in terms of desirable rates of flow of particulate material and desirable levels of drying to be achieved (e.g. percentage reduction in moisture content during a given pass from one end of the drying chamber 106 to the other). Such factors will also determine the size of the master chamber 102 and drying chambers 106 in terms of length and internal bore size.

It should also be noted that whilst the appended claims set out particular combinations of features described above, the scope of the present disclosure is not limited to the particular combinations hereafter claimed, but instead extends to encompass any combination of features herein disclosed.

1. An apparatus for removing moisture from particulate material,
wherein the apparatus comprises a master chamber having a master inlet for the supply of gas to the master chamber;
wherein the apparatus further includes a plurality of drying chambers at least partially arranged within the master chamber;
wherein each drying chamber that is at least partially arranged within the master chamber has a first end and a second end, and wherein each drying chamber is configured for directing a flow of gas-entrained particulate material between said first and second ends of the drying chamber;
further wherein each drying chamber includes a plurality of dryer inlets for directing gas from the master chamber into the drying chamber, for interacting with said flow of gas-entrained particulate material within the drying chamber.

2. The apparatus of claim 1, wherein, in use, the master chamber is arranged in fluid communication with a source of gas under pressure, via said master inlet, whereby each drying chamber is provided with a flow of gas under pressure, via said dryer inlets.

3. The apparatus of claim 1, wherein the apparatus comprises a control system configured to:
monitor flow at or adjacent the first and/or second end of each drying chamber;
for each drying chamber, determine a property indicative of drying performance from the monitored outflow (e.g. moisture content, particulate material concentration, flow rate etc.); and
when it is determined that the property indicative of drying performance in one of the drying chambers is below a threshold value, implement one or more of the following steps:
reduce the inflow of gas-entrained particulate material into said drying chamber;
increase a temperature of gas supplied to the master chamber; and
block outflow from said drying chamber.

4. The apparatus of claim 3, wherein the control system is further configured to vary the rate of gas supplied to the master chamber depending on the monitored outflow of the drying chambers and/or depending on the number of drying chambers which are blocked.

5. The apparatus of claim 4, wherein the control system is configured to reduce the rate of gas supplied to the master chamber when one or more of the drying chambers are blocked.

6. The apparatus of claim 1, further comprising a plurality of control valves which are each located at or adjacent the first and/or second end of one of the drying chambers, wherein each control valve is configured to have a closed state for blocking outflow from the respective drying chamber and an open state for permitting outflow from the respective drying chamber.

7. The apparatus of claim 6, wherein the control system is configured to adjust an opening position of each control valve in order to control outflow from the respective drying chamber.

8. The apparatus of claim 7, wherein the control system is configured to adjust the opening positions of the control valves in order to balance outflow from the plurality of drying chambers.

9. The apparatus of claim 1, wherein each drying chamber is of elongate configuration, having a longitudinal axis extending between said first and second ends.

10. The apparatus of claim 9, wherein each plurality of dryer inlets comprises an array of spaced apart dryer inlets, wherein said dryer inlets are spaced apart in series along the longitudinal axis of the respective drying chamber.

11. The apparatus of claim 9, wherein said plurality of drying chambers are arranged parallel to one another within the master chamber.

12. The apparatus of claim 11, wherein said plurality of drying chambers are arranged spaced apart from one another within the master chamber.

13. The apparatus of claim 11, wherein said plurality of drying chambers are arranged with an air gap about a periphery of each drying chamber, for flow of gas around the periphery of each drying chamber within the master chamber.

14. The apparatus of claim 1, wherein the plurality of drying chambers are mounted on one or more common supports.

15. The apparatus of claim 1, wherein the master chamber is of elongate configuration having a longitudinal axis extending between first and second ends of the master chamber.

16. The apparatus of claim 15, wherein the master chamber comprises opposing end plates.

17. The apparatus of claim 16, wherein the plurality of drying chambers are supported by said end plates.

18. The apparatus of claim 17, wherein the end plates define apertures through which the drying chambers extend.

19. The apparatus of claim 18, wherein the apparatus comprises a plurality of heat-resistant seals (e.g. a heat-resistant compressible seals) between the apertures of the end plates and the respective drying chambers.

20. The apparatus of claim 1, wherein each drying chamber is intended to be mounted with a longitudinal axis of each drying chamber arranged horizontally.
